(19) United States
(12) Patent Application Publication
(10) Pub. No.: US 2015/0260897 A1
(43) Pub. Date: Sep. 17, 2015

(54) LIGHT GUIDE PLATE, BACKLIGHT SOURCE ASSEMBLY AND DISPLAY APPARATUS

(71) Applicants: BOE TECHNOLOGY GROUP CO., LTD., Beijing (CN); HEFEI BOE DISPLAY LIGHT CO., LTD., Anhui (CN)

(72) Inventors: Shuyong He, Beijing (CN); Gang Liu, Beijing (CN)

(21) Appl. No.: 14/445,817

(22) Filed: Jul. 29, 2014

(30) Foreign Application Priority Data
Mar. 17, 2014 (CN) 201410099183.7

(51) Int. Cl. F21V 8/00

(52) U.S. Cl. CPC G02B 6/002; G02B 6/0073

(57) ABSTRACT

The present invention discloses a light guide plate, a backlight source assembly and a display apparatus. The light guide plate comprises: a light incident surface formed with a plurality of first microstructures thereon, the plurality of first microstructures being configured to deflect a part of light entering through the light incident surface toward the light incident surface of the light guide plate; and at least one cavity inside the light guide plate, a side wall of each cavity distant from the light incident surface being formed with a plurality of second microstructures thereon, the plurality of second microstructures being configured to further deflect a part of the light striking on the second microstructures through the cavity toward the light incident surface of the light guide plate. The light guide plate of the present invention of the present invention is able to reduce an area of a dark strip zone occurring at a light incident portion of the light guide plate, thus alleviating the phenomenon of alternate bright and dark strip zones occurring at the light incident portion of the light guide plate, thereby improving display performance of the display apparatus.

### CROSS-REFERENCE TO RELATED APPLICATION

This application claims the benefit of Chinese Patent Application No. 201410099183.7 filed on Mar. 17, 2014 in the State Intellectual Property Office of China, the whole disclosure of which is incorporated herein by reference.

### BACKGROUND OF THE INVENTION

1. Field of the Invention

Embodiments of the present invention generally relate to the field of display technique, in particular to a light guide plate, a backlight source assembly and a display apparatus.

2. Description of the Related Art Currently, a display apparatus typically comprises a display panel which does not emit light itself and a backlight source assembly which is connected to the display panel to provide a light source for normal display of the display panel. Thus, the light-emitting effect of the backlight source assembly will directly affect display performance of the display panel.

The backlight source assembly generally comprises a light source module and a light guide plate. The light source module generally includes a support frame and a plurality of light-emitting diodes (LED) mounted on the support frame. However, because the LED is a point light source which emits light of high directivity and a gap is formed between the adjacent LEDs on the support frame, a region of a light incident portion of the light guide plate directly opposite to the LED has a higher brightness, while a region of the light incident portion of the light guide plate between the adjacent LEDs has a lower brightness, thus the side of the light guide plate close to the light incident portion will have bright and dark strip zones which are alternately arranged. If such alternate bright and dark strip zones extend to a effective light-emitting region of the light guide plate, it is easy to cause a difference in brightness of the backlight emitted by the backlight source assembly, which may cause defects in display images displayed on the display apparatus and thus adversely affect the display performance of the display apparatus. Therefore, it is important to alleviate the phenomenon of uneven brightness in the light guide plate to enhance uniformity of the light.

In order to alleviate the phenomenon that bright and dark strip zones alternately occur in the light incident portion of the light guide plate, as shown in FIG. 1, it is known in the art that microstructures such as V-shaped projected teeth 02 are provided on a light incident side of the light guide plate 01 to redirect the light so as to expand an irradiation range of the light entering the light guide plate and reduce the area of such bright and dark strip zones.

However, when a gap between the light sources at the light incident portion of the light guide plate is large, for example, when the gap between the two adjacent LEDs on the LED support frame is relatively large, as shown in FIG. 1, a width of a dark strip zone D in the light guide plate corresponding to a portion between the two LEDs 03 and a length of the dark strip zone D in the light guide plate in a direction perpendicular to a light incident surface are both larger. Even if the light guide plate 01 is provided with the V-shaped projected teeth 02 at the light incident side thereof, it is difficult to effectively alleviate the phenomenon of alternate bright and dark strip zones in the light incident portion of the light guide plate.

### SUMMARY OF THE INVENTION

The present invention provides a light guide plate, a backlight source assembly and a display apparatus which may reduce an area of a dark strip zones occurring at a light incident portion of the light guide plate, thus alleviating the phenomenon of alternate bright and dark strip zones occurring in the light incident portion of the light guide plate.

According to an embodiment of the present invention, there is provided a light guide plate comprising: a light incident surface formed with a plurality of first microstructures thereon, the plurality of first microstructures being configured to deflect a part of light entering through the light incident surface toward the light incident surface of the light guide plate; and at least one cavity inside the light guide plate, a side wall of each cavity distant from the light incident surface being formed with a plurality of second microstructures thereon, the plurality of second microstructures being configured to further deflect a part of the light striking on the second microstructures through each cavity toward the light incident surface of the light guide plate.

According to another embodiment of the present invention, there is provided a backlight source assembly comprising the light guide plate as described above and a light source module opposite to the light guide plate. According to yet another embodiment of the present invention, there is provided a display apparatus comprising the light guide plate or the backlight source assembly as described above.

### BRIEF DESCRIPTION OF THE DRAWINGS

The above and other features of the present invention will become more apparent by describing in detail exemplary embodiments thereof with reference to the accompanying drawings, in which:

FIG. 1 is a schematic view showing a phenomenon of alternate bright and dark strip zones occurring in a light guide plate having microstructures when being irradiated by LEDs in the prior art;

FIG. 2 is a schematic view of a partial structure of a light guide plate in according with an embodiment of the present invention;

FIG. 3 is a schematic sectional view in a direction A-A in FIG. 2;

FIG. 4 is a schematic sectional view in a direction B-B in FIG. 3;

FIG. 5 is a schematic view showing diffusion of light when the light guide plate shown in FIG. 3 is irradiated by LEDs;

FIG. 6 is a schematic view of an exemplary structure of first microstructures of a light guide plate in accordance with an embodiment of the present invention;

FIG. 7 is a schematic view of another exemplary structure of the first microstructures of the light guide plate in accordance with an embodiment of the present invention;

FIG. 8 is a schematic view of yet another exemplary structure of the first microstructures of the light guide plate in accordance with an embodiment of the present invention; and

FIG. 9 is a schematic view of still another exemplary structure of the first microstructures of the light guide plate in accordance with an embodiment of the present invention.

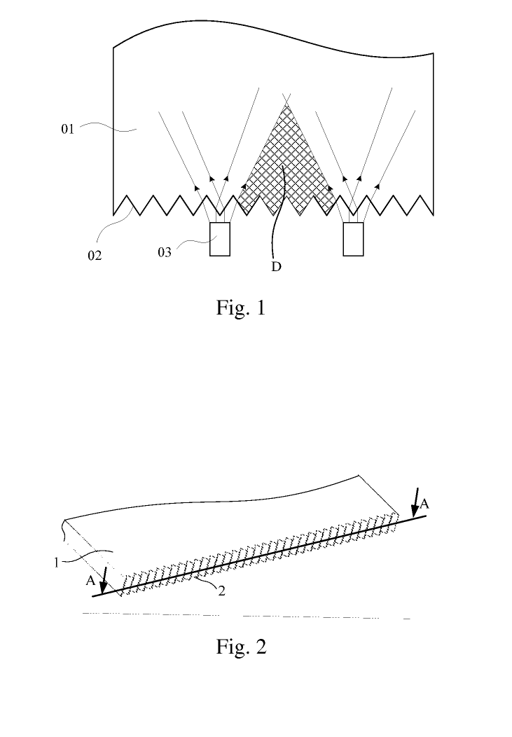

### DETAILED DESCRIPTION OF PREFERRED EMBODIMENTS OF THE INVENTION

An exemplary embodiment of the present invention will be described below with reference to the accompanying drawings. In the following detailed description, for purpose of explanation, numerous specific details are set forth in order to provide a thorough understanding of the disclosed embodiments. It will be apparent, however, that one or more embodiments may be practiced without these specific details. In other instance, well-known structures and devices are schematically shown in order to simplify the drawings.

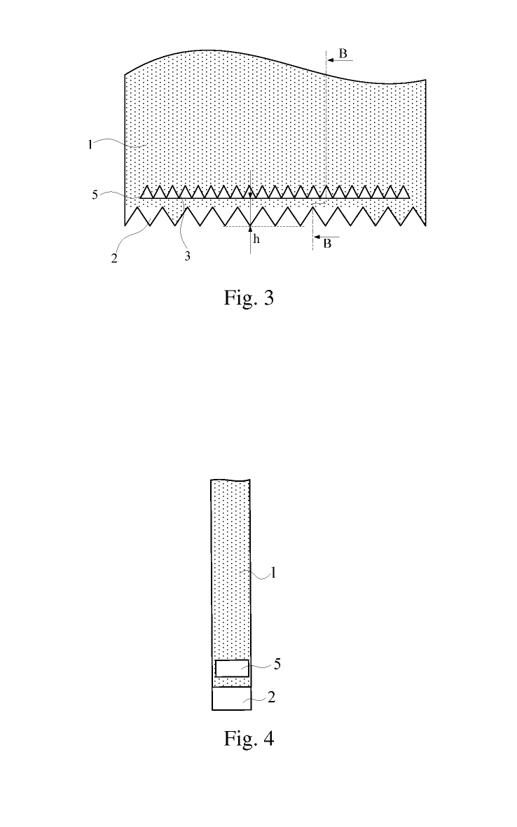

FIG. 2 is a perspective view of a partial structure of a light guide plate in accordance with the present invention. FIG. 3 is a sectional view in a direction A-A in FIG. 2. FIG. 4 is sectional view in a direction B-B in FIG. 3. As depicted in FIGS. 2 to 4, a guide light plate 1 comprises a light incident surface formed with a plurality of first microstructures 2 thereon; and a cavity formed in an interior of the light guide plate close to the light incident surface and extended in a direction substantially parallel to the light incident surface. The cavity has a side wall distant from the light incident surface which is formed with a plurality of second microstructures 3 thereon. The plurality of first microstructures 2 on the light incident surface of the light guide plate 1 is configured to refract light emitted by each LED on a LED support frame opposite to the light incident surface into the light guide plate 1, so that the light entering through the light incident surface is diffused outwardly with respect to an light incident direction. The plurality of the second microstructures 3 in the interior of the light guide plate 1 is configured to refract the light having been refracted by the plurality of first microstructures 2 and entered the light guide plate 1 again, so that the light striking on the second microstructures 3 is further diffused outwardly.

In the example described above, LEDs are used as the light source, however, this is only for illustration rather than for limitation. According to other embodiments, the light source may be for example a cold cathode fluorescent lamp (CCFL).

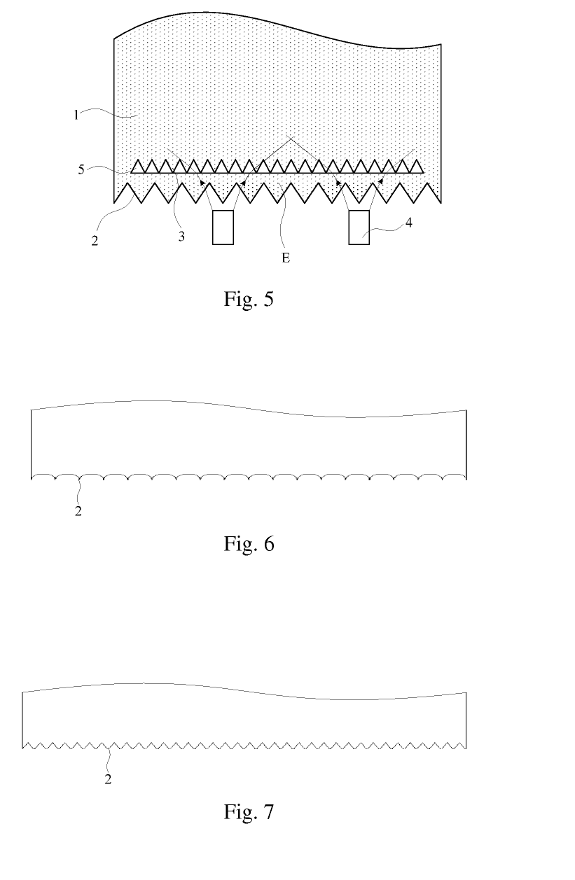

FIG. 5 is a schematic view showing diffusion of light when the light guide plate shown in FIG. 3 is irradiated by the LEDs. As depicted in FIG. 5, the light emitted by each of the LEDs 4 is refracted at the first microstructures 2 of the light incident surface of the light guide plate 1 when passing therethrough. After being refracted, a part of light at an edge of the light beam is deflected toward a side close to the light incident surface of the light guide plate 1. The part of light having been refracted by the first microstructures 2, when entering the cavity in the interior of the light guide plate 1, is proceeding from an optically denser medium to an optically thinner medium, so that the part of light is further deflected toward the side close to the light incident surface of the light guide plate 1. Further, the part of light is refracted again at the second microstructures 3 in the cavity when striking on the second microstructures 3, so that a part of the part of light is further deflected toward the side close to the light incident surface of the light guide plate 1 again.

Therefore, in the light beam emitted by each of the LEDs 4 on the LED support frame, the light enters an effective light-emitting region of the light guide plate 1 through at least three refractions, each of which deflects a part of light at the edge of the light beam emitted by each of the LEDs 4 toward the side close to the light incident surface of the light guide plate 1, so that the light emitted by each of the LEDs 4 is diffused outwardly in the light guide plate 1, thereby expanding an irradiation range of the light beam emitted by each LED 4 and reducing an area of a dark strip zones E occurring in the light guide plate 1 between the light beams emitted by any two adjacent LEDs 4, thus alleviating the phenomenon that the bright and dark strip zones are alternately occurring in the light incident portion of the light guide plate.

Therefore, the light guide plate according to the present embodiment can reduce the area of the dark strip zones in the light incident portion of the light guide plate, thus alleviating the phenomenon that the bright and dark strip zones are alternately occurring in the light incident portion of the light guide plate.

In addition, in the embodiment as shown in FIG. 3, the apexes of the second microstructures 3 abut against a side wall of the cavity close to the light incident surface of the light guide plate 1 so as to divide the entire cavity into a plurality of small cavities 5, so that a volume of the light guide plate 1 occupied by the cavity can be reduced, thus the light guide plate 1 can be sufficiently utilized. However, the embodiment described above is not restrictive, and the apexes of the microstructures 3 may be spaced apart from the side wall of the cavity close to the light incident surface of the light guide plate 1.

According to an embodiment of the present invention, the light guide plate 1 may be formed by a 3D printing technology, and the first microstructures 2, the cavity and the second microstructures 3 in the light guide plate 3 may be integrally formed with the light guide plate 1 when manufacturing the light guide plate 1 by the 3D printing technology.

Since the 3D printing technology is a process to construct an object having a particular structure by a layer-by-layer printing using bonding materials such as powder metals, resins or the like based on a mathematical model file, the light guide plate can be formed by the 3D printing technology without any molds, in this case, it is possible to increase productivity of the light guide plate and reduce cost of production. As shown in FIGS. 3 and 4, the apexes of the plurality of first microstructures 2 are located in the same first plane, the apexes of the plurality of second microstructures 3 are located in the same second plane, and the first plane in which the apexes of the plurality of first microstructures 2 are located is parallel with the second plane in which the apexes of the plurality of second microstructures 3 are located.

In this way, all of the light refracted to the interior of the light guide plate 1 through the first microstructures 2 can be irradiated into the cavity and onto the second microstructures 3 in the cavity after propagating a predetermined distance, so that the light at the edge of the beam emitted by each of the LEDs 4 can be refracted again when passing through the cavity and the second microstructures 3, thus it is possible to effectively expand the irradiation range of the light beams emitted by each LED 4 and reduce the area of the dark strip zones

E in the light guide plate 1 between the light beams emitted by any two adjacent LEDs 4, so that the light entering the light guide plate 1 is distributed more uniformly in the light guide plate 1, thereby alleviating the phenomenon that the bright and dark strip zones are alternately occurring in the light incident portion of the light guide plate.

Referring to FIG. 4, the spacing h between the first plane in which the apexes of the plurality of first microstructures 2 are located and the second plane in which the apexes of the plurality of second microstructures 3 are located is 2-3 mm, which ensures the strength of a portion of the light guide plate 1 between the plurality of first microstructures 2 and the plurality of second microstructures 3, thus preventing the light guide plate 1 from being deformed and thus adversely affecting the refraction effect of the light through the first microstructures 2.

In the embodiment described above, the light guide plate 1 is formed with one cavity therein, the present invention, however, is not limited thereto. The number of the cavities in the light guide plate may be plural. That is, a plurality of cavities may be formed in turn in the light guide plate 1 near the light incident surface thereof and extend in a direction parallel to the light incident surface of the light guide plate 1, and the plurality of cavities may be spaced apart from one another in a direction perpendicular to the light incident surface.

When there are several cavities, a side wall of each cavity distant from the light incident surface has a plurality of second microstructures 3, and for any two adjacent cavities, the spacing between the second planes in which the apexes of the second microstructures 3 are located is 2-3 mm In this way, it is also possible to ensure the strength of the portion of the light guide plate 1 between the second microstructures 3 in the adjacent cavities, thus preventing the light guide plate 1 from being deformed and thus adversely affecting the refraction effect of the light through the second microstructures 3.

In addition, when there are several cavities, the apexes of the second microstructures 3 in each of the cavities may be located in the same second plane, and the second planes in which the apexes of the second microstructures 3 in the adjacent cavities are located are parallel with one another.

According to an embodiment of the present invention, a size of each of the second microstructures 3 is smaller than that of each of the first microstructures 2, so that the second microstructures 3 is more densely arranged in the cavity, thus increasing the diffusion effect of the light in the light guide plate 1 through the second microstructures 3.

Referring to FIG. 3, the first microstructures 2 are uniformly arranged on the light incident surface of the light guide plate 1, and the second microstructures 3 are uniformly arranged on the side wall of the cavity distant from the light incident surface of the light guide plate 1. The first and second microstructures 2 and 3 are uniformly arranged, so that the light entering the light guide plate 1 can be distributed more uniformly after being diffused through the first and second microstructures 2 and 3.

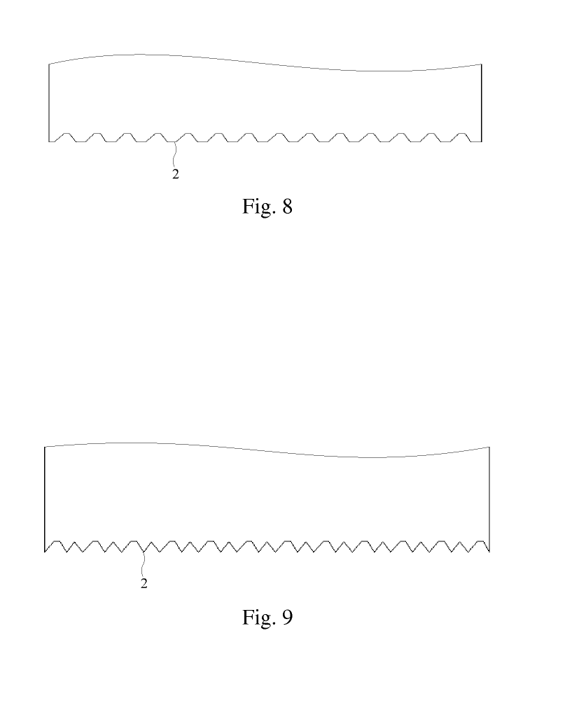

FIGS. 6 to 9 are schematic views showing several exemplary structures of the first microstructures of the light guide plate according to embodiments of the present invention. As shown in FIGS. 6 to 9, the first microstructures 2 are protrusions, and a V-shape groove, a trapezoidal groove or an arc-shaped groove may be formed between any adjacent first microstructures 2. Particularly, as depicted in FIG. 6, the first microstructures 2 are protrusions, and an arc-shaped groove is formed between any adjacent protrusions with an opening thereof being on a side of the light incident surface of the light guide plate 1. As shown in FIG. 7, the first microstructures 2 are protrusions, and a V-shaped groove is formed between any adjacent protrusions with an opening thereof being on a side of the light incident surface of the light guide plate 1. As depicted in FIG. 8, the first microstructures 2 are protrusions, and a trapezoidal groove is formed between any adjacent protrusions with an opening thereof being on a side of the light incident surface of the light guide plate 1. As depicted in FIG. 9, among the grooves formed by the plurality of first microstructures 2, there are V-shaped grooves and trapezoidal grooves, and the V-shaped grooves and the trapezoidal grooves are alternately arranged. Similarly, the second microstructures 3 in the same cavity may also protrusions, and a V-shaped groove, a trapezoidal groove or an arc-shaped groove may be formed between any adjacent second microstructures 3, and an opening of the groove is on a side of the light incident surface of the light guide plate 1.

Similarly, among the grooves formed by the plurality of second microstructures 3 in the same one cavity, there may be V-shaped grooves, trapezoidal grooves and arc-shaped grooves.

Note that, in the same light guide plate 1, the first microstructures 2 and the second microstructures 3 may have same or different shapes. For example, the first microstructures 2 may be trapezoidal protrusions, and the second microstructures 3 may be V-shaped protrusions. Similarly, in the light guide plate 1 having a plurality of cavities, the second microstructures 3 in the adjacent cavities may have the same or different shapes.

Optionally, the number of the second microstructures 3 per unit area is more than that of the first microstructures 2 per unit area to enhance the diffusion effect of the light in the light guide plate through the second microstructures 3, thus further expanding the irradiation range of the light beam emitted by each LED 4 and reducing the area of the dark strip zones E in the light guide plate 1 between the light beams emitted by any two adjacent LEDs 4, thereby alleviating the phenomenon that the bright and dark strip zones are alternately arranged in the light incident portion of the light guide plate.

Furthermore, the number of the first microstructures 2 per unit area and the particular size of each first microstructure 2 may be determined by the actual size of the light guide plate 1, the spacing between the adjacent LEDs 4 on the LED support frame and the like. The number of the second microstructures 3 per unit area and the particular size of each second microstructure 3 may be determined by the number of the first microstructures 2 per unit area and the size of the first microstructures 2, and the like.

According to a second embodiment of the present invention, there is provided a backlight source assembly comprising the light guide plate as described in the first embodiment, and a light source module opposite to the light incident surface of the light guide plate for emitting light to the light incident surface.

According to an example, the light source module comprises a support frame and a plurality of LED light sources mounted on the support frame.

Because the light guide plate as described above can expand the irradiation range of the light beam emitted by each LED and reduce the area of the dark strip zones in the light guide plate between the light beams emitted by any two adjacent LEDs, the area of the dark strip zones in the light guide plate between the light beams emitted by any two adjacent LEDs is small in the backlight module having the light guide plate as described above, thus it is possible to alleviate the phenomenon that the bright and dark strip zones are alternately arranged in the light incident portion of the light guide plate so as to improve the uniformity of backlight emitted by the backlight source assembly.

According to a third embodiment of the present invention, there is provided a display apparatus comprising the light guide plate or the backlight source assembly as described above.

In view of the advantages of the light guide plate or the backlight source assembly as described according to the above embodiments, in the display apparatus having the light guide plate or the backlight source assembly as described above, the uniformity of the backlight emitted from the effective light-emitting region of the light guide plate or the backlight source assembly is improved, thus improving the display performance of the display apparatus.

Although several exemplary embodiments have been shown and described, it would be appreciated by those skilled in the art that various changes or modifications may be made in these embodiments without departing from the principle and spirit of the disclosure, the scope of which is defined in the claims and their equivalents.

What is claimed is:

1. A light guide plate comprising:
a light incident surface formed with a plurality of first microstructures thereon, the plurality of first microstructures being configured to deflect a part of light entering through the light incident surface toward the light incident surface of the light guide plate; and
at least one cavity inside the light guide plate, each cavity having a side wall distant from the light incident surface, which is formed with a plurality of second microstructures thereon, the plurality of second microstructures being configured to further deflect a part of the light striking on the second microstructures through each cavity toward the light incident surface of the light guide plate.

2. The light guide plate according to claim 1, wherein the apexes of the plurality of first microstructures are located in the same first plane, and the apexes of the plurality of second microstructures in each cavity are located in the same second plane which is parallel with the first plane.

3. The light guide plate according to claim 2, wherein the spacing between the first plane in which the apexes of the plurality of first microstructures are located and the second plane adjacent to the first plane in which the apexes of the plurality of second microstructures are located is 2 to 3 mm

4. The light guide plate according to claim 2, wherein the at least one cavity comprises a plurality of cavities, and the spacing between the adjacent second planes in adjacent cavities is 2 to 3 mm

5. The light guide plate according to claim 1, wherein a size of each of the second microstructures is smaller than that of each of the first microstructures.

6. The light guide plate according to claim 1, wherein the number of the second microstructures per unit area is more than that of the first microstructures per unit area.

7. The light guide plate according to claim 1, wherein the first microstructures are uniformly arranged on the light incident surface of the light guide plate, and the second microstructures are uniformly arranged on the side wall of the cavity distant from the light incident surface.

8. The light guide plate according to claim 7, wherein the first and second microstructures are protrusions, and a first V-shaped groove, trapezoidal groove or arc-shaped groove is formed between adjacent first microstructures, and a second V-shaped groove, trapezoidal groove or arc-shaped groove is formed between adjacent second microstructures.

9. The light guide plate according to claim 8, wherein the apexes of the second microstructures abut against a side wall of the cavity close to the light incident surface of the light guide plate.

10. A backlight source assembly, comprising:
the light guide plate according to claim 1; and
a source module facing the light incident surface of the light guide plate.

11. The backlight source assembly according to claim 10, wherein the light source module comprises a support frame and a plurality of LED light sources mounted on the support frame.

12. A display apparatus comprising the light guide plate according to claim 1.
